(19) United States
(12) Patent Application Publication
(10) Pub. No.: US 2022/0013348 A1
(43) Pub. Date: Jan. 13, 2022

(54) Fourier Transform Electrostatic Linear Ion Trap and Reflectron Time-of-Flight Mass Spectrometer

(71) Applicant: DH TECHNOLOGIES DEVELOPMENT PTE. LTD., Singapore (SG)

(72) Inventor: Eric Thomas Dziekonski, Richmon Hill (CA)

(21) Appl. No.: 17/312,902

(22) PCT Filed: Dec. 9, 2019
(86) PCT No.: PCT/IB2019/060574

§ 371 Date: Jun. 10, 2021

Related U.S. Application Data
(60) Provisional application No. 62/779,368, filed on Dec. 13, 2018.

(51) Int. Cl. H01J 49/40; H01J 49/02; H01J 49/42; H01J 49/06; H01J 49/16

(52) U.S. Cl. CPC H01J 49/405; H01J 49/406; H01J 49/164; H01J 49/4245; H01J 49/061; H01J 49/025

(57) ABSTRACT

An MCP detector (620) receives an ion packet along an ion path (601) of mass spectrometer through a hollow central cylindrical tube (621) of the MCP detector. The MCP detector includes coaxial rings (622) of MCPs surrounding the hollow central cylindrical tube. The MCP detector transmits the ion packet along the ion path to an ELIT (610) through holes in the center of a first set of reflectron plates (613) of the ELIT to oscillate the ion packet between the first set and a second set of reflectron plates (614) of the ELIT. The ELIT transmits the oscillated ion packet back to the MCP detector along the ion path through the holes of the first set. The MCP detector detects ions of the oscillated ion packet that are radially deflected from the ion path using the rings of MCPs. The MCP detector allows ions to be transmitted to or from either port of the ELIT.

### RELATED APPLICATIONS

This application claims the benefit of U.S. Provisional Patent Application Ser. No. 62/779,368, filed on Dec. 13, 2018, the content of which is incorporated by reference herein in its entirety.

### INTRODUCTION

The teachings herein relate to a system for detecting ions from an electrostatic linear ion trap (ELIT) using a microchannel plate (MCP) detector that does not physically obstruct an ion path of a mass spectrometer. The use of this MCP detector allows ions to be transmitted to or from either port of the ELIT preventing it from being a terminal device and allowing it to be placed in any location along the ion path of a mass spectrometer. More specifically, an MCP detector, which includes a hollow central cylindrical tube and coaxial rings of MCPs surrounding the hollow central cylindrical tube, is positioned next to an ELIT. The MCP detector allows transmission of ions to the ELIT through the hollow tube and detection of ions transmitted from the ELIT by the coaxial rings of MCPs without obstructing ions from entering or exiting either port of the ELIT.

The systems and methods disclosed herein can be performed in conjunction with a processor, controller, microcontroller, or computer system, such as the computer system of FIG. 1.

### ELIT-MS

An electrostatic linear ion trap mass spectrometer (ELIT-MS) is a type of mass spectrometer. An ELIT-MS includes an ELIT for performing mass analysis of ions. In an ELIT, electric current or charge induced by oscillating ions in the trap is detected. The measured frequency of oscillation of the ions is used to calculate the m/z of the ions. For example, a Fourier transform is applied to the measured induced current.

Dziekonski et al., Int. J. Mass Spectrom. 410 (2016) p 12-21, (the “Dziekonski Paper”) describes an exemplary ELIT. The Dziekonski Paper is incorporated by reference herein.

FIG. 2 is a three-dimensional cutaway perspective view of an exemplary conventional ELIT 200. ELIT 200 is similar to the ELIT of the Dziekonski Paper. ELIT 200 includes first set of electrode plates 210, pickup electrode 215, and second set of electrode plates 220. First set of electrode plates 120 and second set of electrode plates 220 include holes in the center. Note that the end electrodes of first set of electrode plates 210 and second set of electrode plates 220 do not include holes in the center. However, this is only for simulation purposes. In an actual device, these end electrodes include holes in the center for the introduction and removal of ions from ELIT 200.

In ELIT 200, ions are introduced axially and are typically made to oscillate axially. The ions are made to oscillate axially by appropriately biasing first set of electrode plates 210 and second set of electrode plates 220 to reflect the ions. First set of electrode plates 210 and second set of electrode plates 220 are hereinafter referred to as reflectron plates because they are used to reflect ions.

When operated as a Fourier transform (FT) mass analyzer, pickup electrode 215 is used to measure the induced current produced by the oscillating ions. An FT is applied to the digitized signal measured from pickup electrode 215 to obtain the oscillation frequency. From the oscillation frequency or frequencies, the m/z of one or more ions is calculated.

Detection can also be performed on the electrode plates, using multiple electrodes, shaped electrodes, or any combination of those listed.

### Terminal Device Problem

In addition to being used as an FT mass analyzer, an ELIT can be used as a “drift tube” time-of-flight (TOF) mass analyzer and as a multiple-reflection (MR) TOF mass analyzer. To perform both drift tube TOF and MR-TOF mass analysis, a microchannel plate (MCP) detector is added at the exit port of the ELIT. This MCP detector destructively detects ions exiting the ELIT along the axis of the ELIT during drift tube TOF and MR-TOF mass analysis.

FIG. 3 is an exemplary side view 300 of an ELIT and a conventional microchannel plate (MCP) detector at the exit port of the ELIT and shows how the ELIT performs a drift tube TOF mass analysis. In FIG. 3, MCP detector 320 is placed after ELIT 310. During drift tube TOF mass analysis, an ion packet is received along ion path 301 from an ion buncher (not shown) into ELIT 310 through entrance port 311. The ions of the ion packet are allowed to travel straight through ELIT 310 and out of exit port 312 along ion path 301, after which they impinge upon MCP detector 320. This mode of operation is extremely fast, and the m/z range is only limited by the detection efficiency of MCP detector 320.

However, because no reflectrons of ELIT 310 are utilized, the kinetic energy (KE) distribution of the ion packet is not compensated for, leading to poor resolution at MCP detector 320.

Drift tube TOF mass analysis can also be used to tune the device. For example, it is used to identify that ions are present, perform automatic gain control, tune the ion beam, or tune ion injection.

FIG. 4 is an exemplary side view 400 of an ELIT and a conventional MCP detector at the exit port of the ELIT and shows how the ELIT performs a multiple-reflection (MR) TOF mass analysis. In FIG. 4, MCP detector 320 is again located after ELIT 310. During MR-TOF mass analysis, an ion packet is received along ion path 301 from an ion buncher (not shown) into ELIT 310 through entrance port 311. Ions of the ion packet are then oscillated back and forth along the axis of ELIT 310 using reflectrons 313 and 314. Finally, ions of the oscillated ion packet are ejected through exit port 312 and measured by MCP detector 320. MR-TOF mass analysis is fast and provides a very high resolution (˜300,000-500,000). In this configuration, when the reflectrons of an ELIT are used to compensate for the KE distribution (requires two or more bounces), this automatically invokes the racetrack effect and makes the assignments in the mass spectrum ambiguous. The unambiguous m/z range decreases with trapping time. This is a result of the closed (folded) ion path in the ELIT.

Considering the time-scale of FT or MR-TOF mass analysis, it could be beneficial to perform a fast, low-resolution drift-tube TOF experiment to locate regions of ion density in the mass spectrum prior to performing any FT or MR-TOF experiments. The higher the resolution of the TOF experiment, the easier it is to narrow in on the regions to interrogate with very high resolution. This is critical when interrogating peaks eluting from an LC column, as the number of possible analyses is limited.

FIG. 5 is an exemplary side view 500 of an ELIT and a conventional MCP detector at the exit port of the ELIT and shows how the ELIT performs a Fourier transform (FT) mass analysis. In FIG. 5, MCP detector 320 is again located after ELIT 310. During FT mass analysis, an ion packet is received along ion path 301 from an ion buncher (not shown) into ELIT 310 through entrance port 311. Ions of the ion packet are then oscillated back and forth along the axis of ELIT 310 using reflectrons 313 and 314. Finally, as described above, an induced current signal of the oscillated ion packet is measured by pickup electrode 315. An FT is applied to the digitized signal to obtain the oscillation frequency. From the oscillation frequency or frequencies, the m/z of one or more ions of the oscillated ion packet is calculated. FT mass analysis is slower than drift tube TOF or MR-TOF analysis, but provides both a high resolution and a broad m/z range.

MCP detector 320 is not used in FT mass analysis. However, the inclusion of MCP detector 320 allows ELIT 310 to be tuned and enables ELIT 310 to be used in the other modes of operations depicted in FIGS. 3 and 4.

Unfortunately, however, the inclusion of MCP detector 320 also creates a problem. As FIGS. 3, 4, and 5 show, the inclusion of MCP detector 320 makes ELIT 310 a terminal device. In other words, ELIT 310 is the last element that can be used to analyze ions along ion path 301. No other mass spectrometry devices can be placed after ELIT 310 and MCP detector 320 because MCP detector 320 physically obstructs ion path 301.

More specifically, no other mass spectrometry devices can be placed after ELIT 310 without breaking vacuum or including additional instrumentation. For example, it is possible to include an ultra-high vacuum manipulator (not shown), which allows MCP detector 320 to be removed from the ion path without breaking vacuum. However, this either requires the user themselves to go under the hood of the instrument and manipulate the position of MCP detector 320, or it requires a motorized stage to be included. In either case, any resulting TOF spectrum will be highly dependent on the position of MCP detector 320 and will require additional tuning. In general, this is not a good option for customers who do not understand the inner workings of a mass spectrometer.

As a result, additional systems and methods are needed to detect ions from an ELIT that does not require using an MCP detector that obstructs the ion path of a mass spectrometer.

### SUMMARY

A system, method, and a computer program product are disclosed for detecting ions from an ELIT using an MCP detector that does not physically obstruct an ion path of a mass spectrometer.

The system includes an ELIT and an MCP detector. The ELIT includes a first set of reflectron plates and a second set of reflectron plates. Each plate of the first set of reflectron plates includes a hole in the center and is aligned along an ion path of a mass spectrometer. Each plate of the second set of reflectron plates similarly includes a hole in the center and is aligned with the first set along the ion path.

The MCP detector includes coaxial rings of MCPs surrounding a hollow central cylindrical tube. The MCP detector is aligned with the first set of reflectron plates along the ion path. The MCP detector is positioned on the side of the first set of reflectron plates opposite the second set of reflectron plates.

The MCP detector receives an ion packet along the ion path through the hollow central cylindrical tube. The MCP detector transmits the ion packet along the ion path to the ELIT through the holes of the first set of reflectron plates for at least one oscillation between the first set of reflectron plates and the second set of reflectron plates.

The ELIT transmits the oscillated ion packet back to the MCP detector along the ion path through the holes of the first set of reflectron plates. The MCP detector detects ions of the oscillated ion packet that are radially deflected from the ion path using the rings of MCPs.

These and other features of the applicant's teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is a three-dimensional cutaway perspective view of an exemplary conventional electrostatic linear ion trap (ELIT).

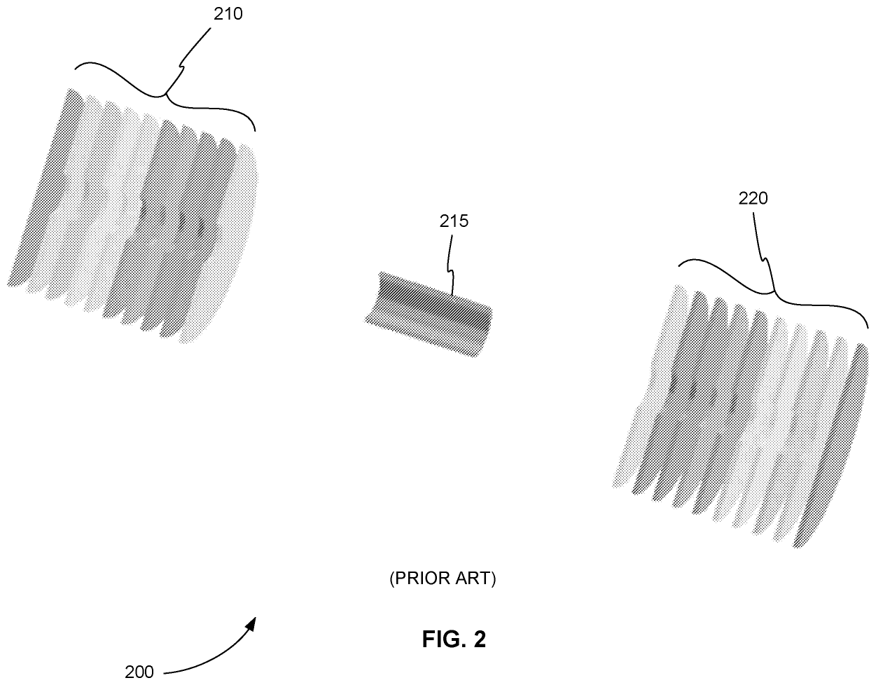

FIG. 3 is an exemplary side view of an ELIT and a conventional microchannel plate (MCP) detector at the exit port of the ELIT and shows how the ELIT performs a drift tube TOF mass analysis.

FIG. 4 is an exemplary side view of an ELIT and a conventional MCP detector at the exit port of the ELIT and shows how the ELIT performs a multiple-reflection (MR) TOF mass analysis.

FIG. 5 is an exemplary side view of an ELIT and a conventional MCP detector at the exit port of the ELIT and shows how the ELIT performs a Fourier transform (FT) mass analysis.

FIG. 6 is an exemplary side view of an ELIT and an MCP detector that includes coaxial rings of MCPs surrounding a hollow central cylindrical tube and that is positioned at the entrance port of the ELIT and shows how the ELIT performs reflectron (R) TOF mass analysis without obstructing the ion path, in accordance with various embodiments.

FIG. 7 is an exemplary side view of an ELIT and an MCP detector that includes coaxial rings of MCPs surrounding a hollow central cylindrical tube and that is positioned at the entrance port of the ELIT and shows how the ELIT performs MR-TOF mass analysis without obstructing the ion path, in accordance with various embodiments.

FIG. 8 is an exemplary side view of an ELIT and an MCP detector that includes coaxial rings of MCPs surrounding a hollow central cylindrical tube and that is positioned at the entrance port of the ELIT and shows how the ELIT performs FT mass analysis without obstructing the ion path, in accordance with various embodiments.

FIG. 9 is an exemplary side view of an ELIT and an MCP detector that includes coaxial rings of MCPs surrounding a hollow central cylindrical tube and that is positioned at the entrance port of the ELIT and shows how the ELIT performs ion transmission, in accordance with various embodiments.

FIG. 10 is an exemplary side view of an ELIT and an MCP detector that includes coaxial rings of MCPs surrounding a hollow central cylindrical tube and that is positioned at the entrance port of the ELIT and shows how the ELIT performs ionization, in accordance with various embodiments.

FIG. 11 is an exemplary side view of an ELIT and an MCP detector that includes coaxial rings of MCPs surrounding a hollow central cylindrical tube and that is positioned at the entrance port of the ELIT and shows how the ELIT performs in-situ ion fragmentation, in accordance with various embodiments.

FIG. 12 is an exemplary side view of an ELIT and an MCP detector that includes coaxial rings of MCPs surrounding a hollow central cylindrical tube and that is positioned at the entrance port of the ELIT and shows how the ELIT performs surface induced dissociation (SID), in accordance with various embodiments.

FIG. 13 is a perspective front view of the MCP detector of U.S. Pat. No. 6,943,344.

FIG. 14 is an expanded cutaway side view of the MCP detector of U.S. Pat. No. 6,943,344.

FIG. 15 is a schematic diagram of a system for detecting ions from an ELIT using an MCP detector that does not physically obstruct an ion path of a mass spectrometer, in accordance with various embodiments.

FIG. 16 is a flowchart showing a method for detecting ions from an ELIT using an MCP detector that does not physically obstruct an ion path of a mass spectrometer, in accordance with various embodiments.

FIG. 17 is a schematic diagram of a system that includes one or more distinct software modules that perform a method for detecting ions from an ELIT using an MCP detector that does not physically obstruct an ion path of a mass spectrometer, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

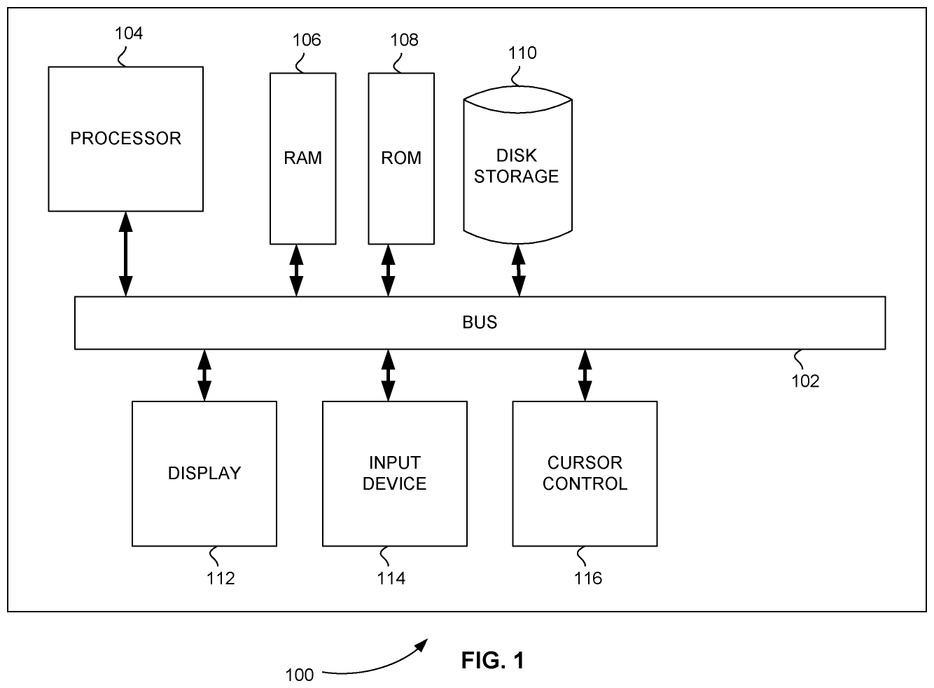

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

In various embodiments, computer system 100 can be connected to one or more other computer systems, like computer system 100, across a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Non-Obstructing MCP Detector

As described above, in addition to being used as an FT mass analyzer, an ELIT can be used as a “drift tube” TOF mass analyzer and as an MR-TOF mass analyzer. To perform both drift tube TOF and MR-TOF mass analysis, an MCP detector is conventionally added in the ion path at the exit port of the ELIT.

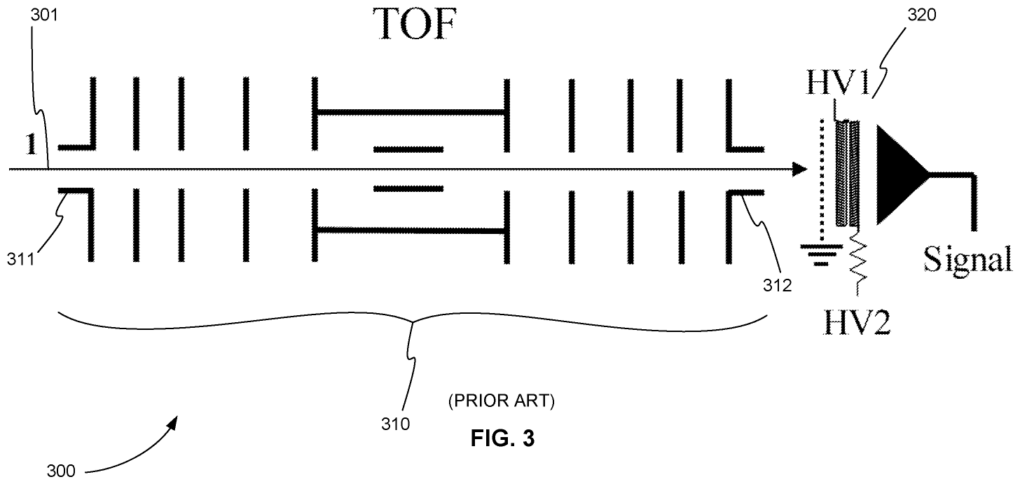

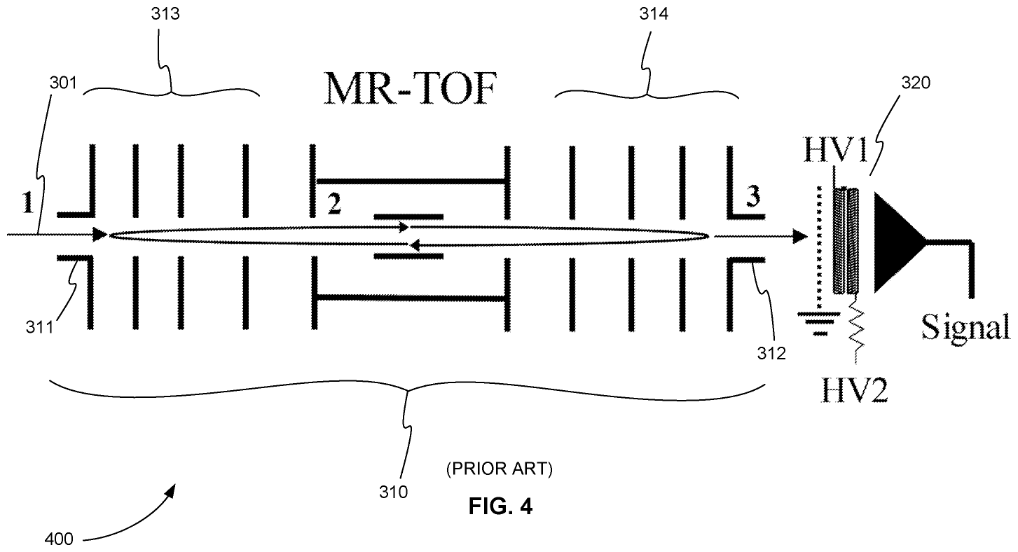

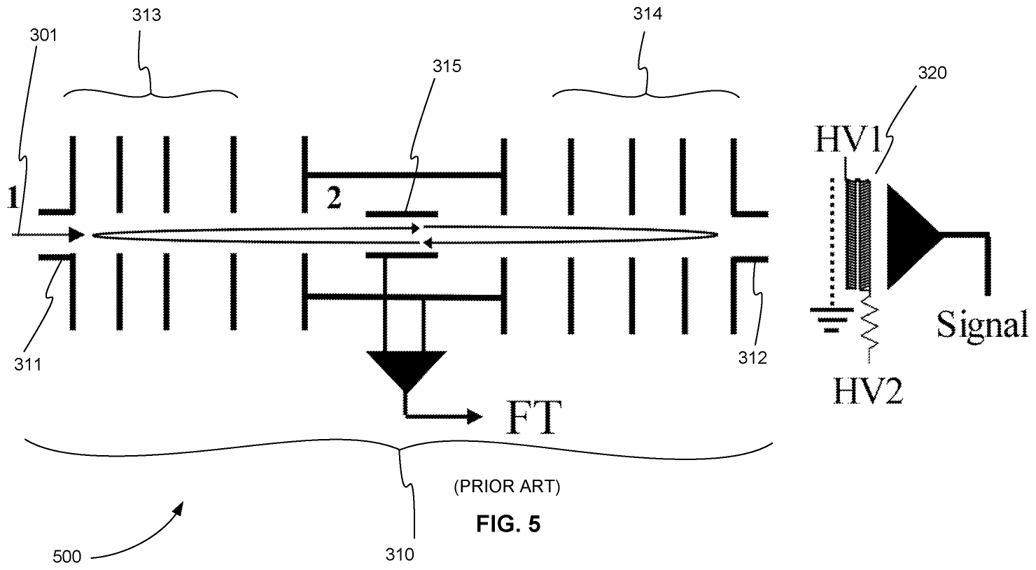

As FIGS. 3, 4, and 5 show, however, the inclusion of an MCP detector in the ion path obstructs the ion path. The MCP does not allow for ion transmission and is used for destructive ion detection. This makes the ELIT a terminal device. In other words, it is the last element that can be used to analyze ions traveling along the ion path of the mass spectrometer. No other mass spectrometry devices can be placed after the ELIT and MCP.

As a result, additional systems and methods are needed to detect ions from an ELIT that does not require using an MCP detector that obstructs the ion path of a mass spectrometer.

In various embodiments, ions are detected from an ELIT using an MCP detector that does not physically obstruct an ion path of a mass spectrometer. The MCP detector includes coaxial rings of MCPs surrounding a hollow central cylindrical tube.

This MCP detector can be placed in the ion path between an injection device and the ELIT. An injection device for an ELIT can include, but is not limited to, an ion buncher. The central tube of the MCP detector can be used as the conductance limiting aperture to ultra-high vacuum if desired. To get the ions to fan out and hit the MCP detector, the central tube can be made repulsive once ions pass through, or an additional optical element can be included which is seated around the tube.

As the MCP no longer needs to be the terminal element, this allows for many modes of operation that do not require user intervention. These modes can also be customized to fit a particular customer need.

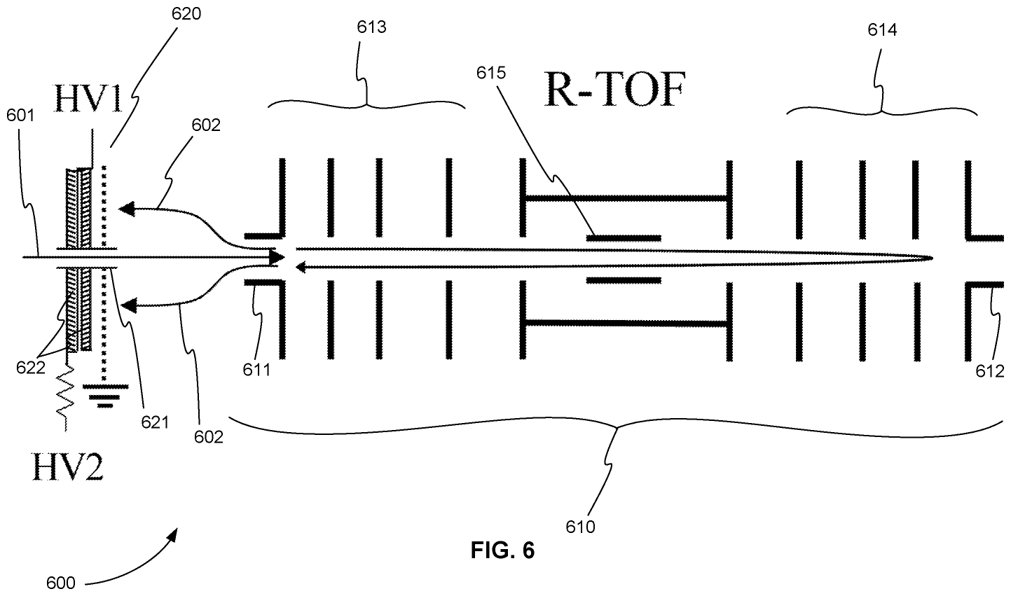

FIG. 6 is an exemplary side view 600 of an ELIT and an MCP detector that includes coaxial rings of MCPs surrounding a hollow central cylindrical tube and that is positioned at the entrance port of the ELIT and shows how the ELIT performs reflectron (R) TOF mass analysis without obstructing the ion path, in accordance with various embodiments. In FIG. 6, MCP detector 620 is placed in front of ELIT 610.

During R-TOF mass analysis, an ion packet is received along ion path 601 from an ion buncher (not shown) into MCP detector 620 through hollow central cylindrical tube 621. MCP detector 620 transmits the ion packet along ion path 601 to ELIT 610 through the holes of first set of reflectron plates 613 for just one oscillation or bounce between first set of reflectron plates 613 and second set of reflectron plates 614.

ELIT 610 transmits the oscillated ion packet after one bounce to MCP detector 620 back along ion path 601 through the holes of first set of reflectron plates 613. MCP detector 620 detects ions 602 of the oscillated ion packet that are radially deflected from ion path 601 using coaxial rings of MCPs 622.

Note that MCP detector 620 does not physically obstruct ions from entering or exiting either entrance port 611 or exit port 612 of ELIT 610. As a result, ELIT 610 is not a terminal device and can be placed in any location along the ion path of a mass spectrometer. Note also that pickup electrode 615 does not participate in the R-TOF mass analysis. Finally, note that although MCP detector 620 is shown as being biased with a first high voltage (HV1), a second high voltage (HV2), and a grounded grid, MCP detector 620 is not limited to any particular biasing configuration.

The single bounce produced by second set of reflectron plates 614 compensates for the KE distribution of the ion packet. In various embodiments, more plates can be included in first set of reflectron plates 613 and second set of reflectron plates 614 to provide more uniform focusing across a wider KE range. As ions are unable to lap one another in the R-TOF ion trajectory, no racetrack effect is produced and an unambiguous mass spectrum is generated.

In summary, the R-TOF mass analysis of FIG. 6 is fast. It provides a mass resolution of up to several thousand and a broad m/z range. Finally, as described above, the one reflection of the ion packet compensates for the KE distribution of the ion packet.

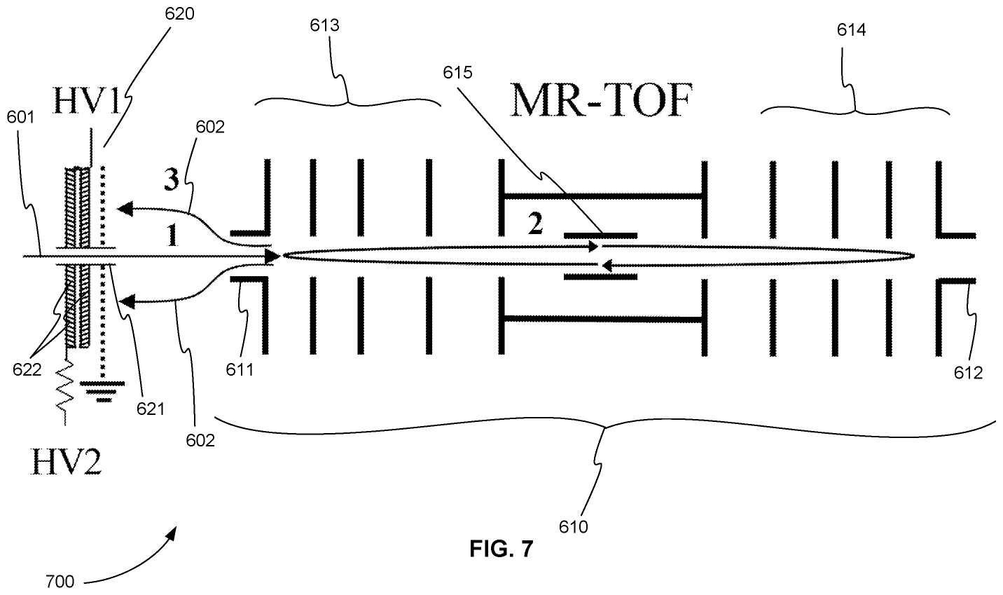

FIG. 7 is an exemplary side view 700 of an ELIT and an MCP detector that includes coaxial rings of MCPs surrounding a hollow central cylindrical tube and that is positioned at the entrance port of the ELIT and shows how the ELIT performs MR-TOF mass analysis without the MCP obstructing the ion path, in accordance with various embodiments. In FIG. 7, MCP detector 620 is again in front of ELIT 610.

During MR-TOF mass analysis, an ion packet is also received along ion path 601 from an ion buncher (not shown) into MCP detector 620 through hollow central cylindrical tube 621. MCP detector 620 again transmits the ion packet along ion path 601 to ELIT 610 through the holes of first set of reflectron plates 613 for oscillation between first set of reflectron plates 613 and second set of reflectron plates 614. However, in MR-TOF mass analysis, ELIT 610 oscillates the ion packet more than once between first set of reflectron plates 613 and second set of reflectron plates 614.

ELIT 610 transmits the oscillated ion packet after multiple oscillations to MCP detector 620 back along ion path 601 through the holes of first set of reflectron plates 613. MCP detector 620 detects ions 602 of the oscillated ion packet that are radially deflected from ion path 601 using coaxial rings of MCPs 622 or some other means (deflection electrodes, etc.).

Note again that MCP detector 620 does not physically obstruct ions from entering or exiting either entrance port 611 or exit port 612 of ELIT 610. As a result, ELIT 610 is not a terminal device and can be placed in any location along the ion path of a mass spectrometer. Note also that pickup electrode 615 does not participate in the R-TOF mass analysis.

In summary, the MR-TOF mass analysis of FIG. 7 is fast and provides a very high resolution (˜300,000-500,000). However, the closed path of the ELIT invokes the racetrack effect and causes the unambiguous m/z range decreases with trapping time.

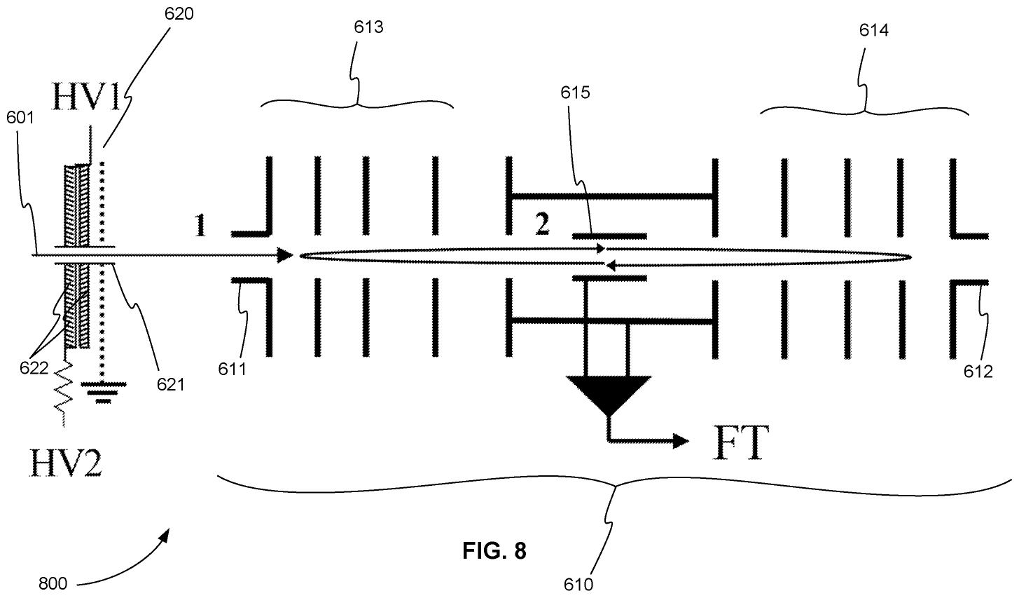

FIG. 8 is an exemplary side view 800 of an ELIT and an MCP detector that includes coaxial rings of MCPs surrounding a hollow central cylindrical tube and that is positioned at the entrance port of the ELIT and shows how the ELIT performs FT mass analysis without obstructing the ion path, in accordance with various embodiments. In FIG. 8, MCP detector 620 is again in front of ELIT 610.

During FT mass analysis, an ion packet is also received along ion path 601 from an ion buncher (not shown) into MCP detector 620 through hollow central cylindrical tube 621. MCP detector 620 again transmits the ion packet along ion path 601 to ELIT 610 through the holes of first set of reflectron plates 613 for oscillation between first set of reflectron plates 613 and second set of reflectron plates 614.

However, in FT mass analysis, ELIT 610 oscillates the ion packet between first set of reflectron plates 613 and second set of reflectron plates 614 to induce a current on pickup electrode 615. The induced current, or charge, is then used to calculate m/z values for ions of the oscillating ion packet.

In FT mass analysis, ELIT 610 does not transmit the oscillated ion packet back to MCP detector 620. As a result, coaxial rings of MCPs 622 of MCP detector 620 are not used in FT mass analysis.

Note again that MCP detector 620 still does not physically obstruct ions from entering or exiting either entrance port 611 or exit port 612 of ELIT 610. As a result, ELIT 610 is not a terminal device and can be placed in any location along the ion path of a mass spectrometer.

In summary, the FT mass analysis of FIG. 8 is slower than MR-TOF mass analysis and provides a high resolution. However, FT mass analysis can provide a broad m/z range.

FIGS. 6, 7, and 8 show that using an MCP detector made up of coaxial rings of MCPs surrounding a hollow central cylindrical tube can allow an ELIT to be used for different modes of operation without obstructing the ion path of a mass spectrometer. This allows the ELIT to be located anywhere in the ion path and allows for additional modes of operation and interaction with additional mass spectrometry devices.

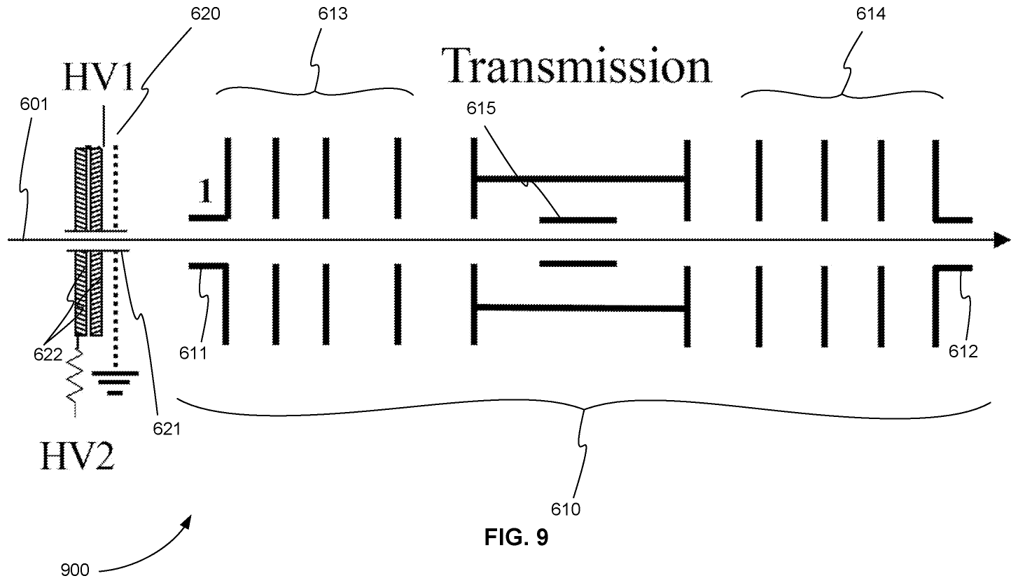

FIG. 9 is an exemplary side view 900 of an ELIT and an MCP detector that includes coaxial rings of MCPs surrounding a hollow central cylindrical tube and that is positioned at the entrance port of the ELIT and shows how the ELIT performs ion transmission, in accordance with various embodiments. In FIG. 9, MCP detector 620 is again in front of ELIT 610.

During ion transmission, an ion packet is also received along ion path 601 from an ion buncher (not shown) into MCP detector 620 through hollow central cylindrical tube 621. However, during ion transmission, MCP detector 620 transmits the ion packet along ion path 601 to ELIT 610 through the holes of first set of reflectron plates 613 for transmission of the ion packet from first set of reflectron plates 613 to second set of reflectron plates 614 and out of ELIT 610 through the holes of second set of reflectron plates 614 to another device of the mass spectrometer (not shown). Another device of the mass spectrometer can include any optical element, such as a quadrupole, Orbitrap, TOF, etc.

For example, a quadrupole can be used to store and build an ion population. An ELIT is capable of high-resolution mass isolation. As ions oscillate in an ELIT they separate in space. As a result, isotopes that are close in mass separate in space in the ELIT. These separated isotopes can be stored in quadrupole located after the ELIT. Additionally, these separated isotopes can later be reanalyzed or fragmented, for example. Most simply, an ELIT that is not a terminal device can perform high-resolution mass isolation for other devices.

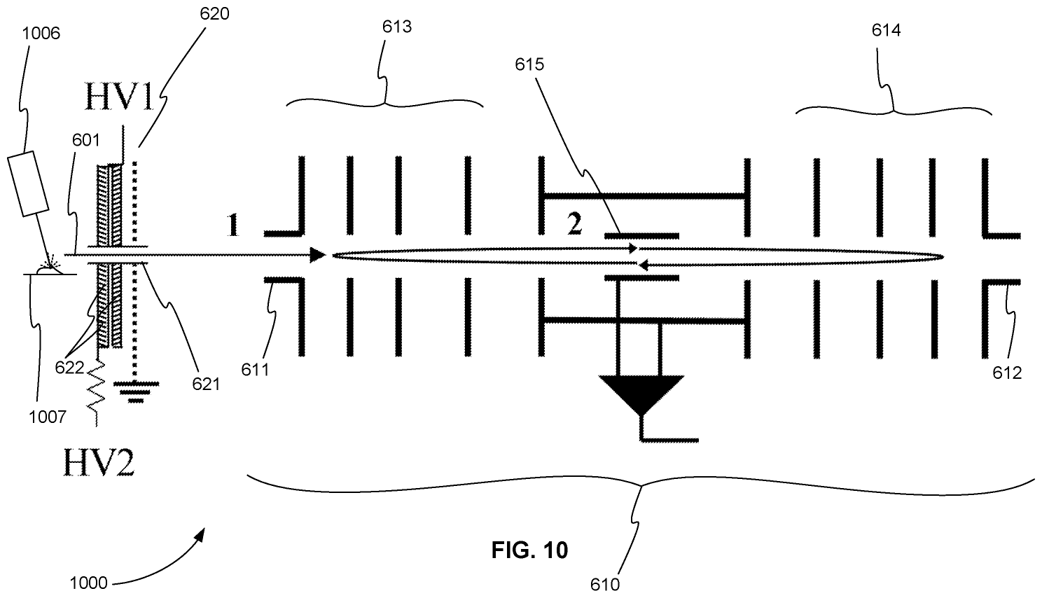

FIG. 10 is an exemplary side view 1000 of an ELIT and an MCP detector that includes coaxial rings of MCPs surrounding a hollow central cylindrical tube and that is positioned at the entrance port of the ELIT and shows how ionization is performed, in accordance with various embodiments. In FIG. 10, MCP detector 620 is again in front of ELIT 610. Laser 1006 and surface 1007 for receiving a sample are further positioned on the side of MCP detector 620 opposite ELIT 610.

Laser 1006 ionizes a sample on surface 1007 using matrix-assisted laser desorption/ionization (MALDI) to produce an ion packet. The ion packet is received along ion path 601 into MCP detector 620 through hollow central cylindrical tube 621. MCP detector 620 can transmit the ion packet along ion path 601 to ELIT 610 for any type of mass analysis or for ion transmission. FT mass analysis is shown in FIG. 10, for example.

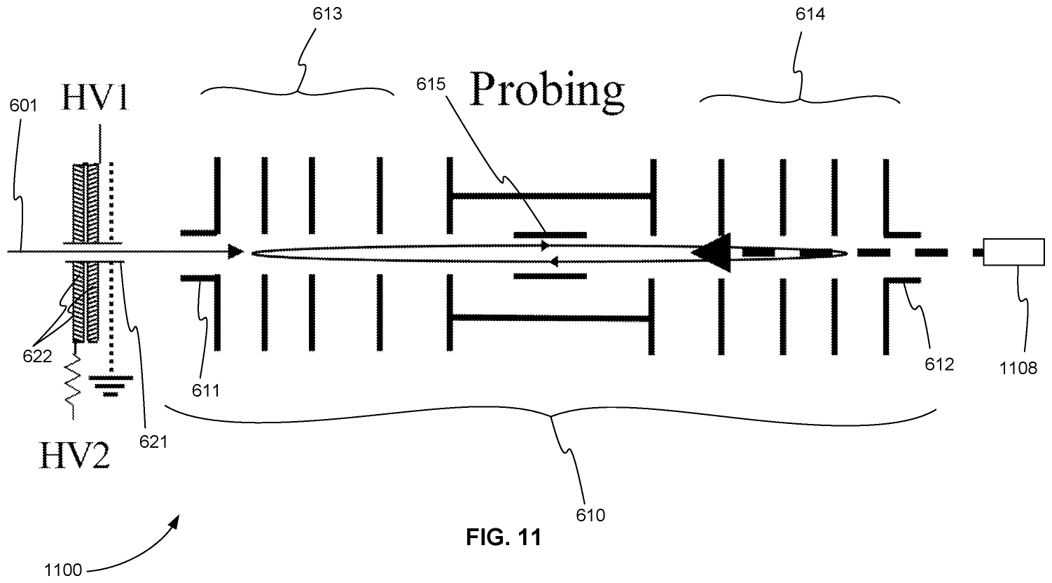

FIG. 11 is an exemplary side view 1100 of an ELIT and an MCP detector that includes coaxial rings of MCPs surrounding a hollow central cylindrical tube and that is positioned at the entrance port of the ELIT and shows how the ELIT performs in-situ ion fragmentation, in accordance with various embodiments. In FIG. 11, MCP detector 620 is again in front of ELIT 610. Particle beam source 1108 is further positioned on the side of ELIT 610 opposite MCP detector 620. Particle beam source 1108 can also be positioned radially around ELIT 610, ideally placed such that the beam interacts with the oscillating ion packet only at the turning point.

Particle beam source 1108 directs a beam of particles along ion path 601 and through the holes of second set of reflectron plates 614 to in situ fragment an oscillated or oscillating ion packet. The oscillating ion packet shown in FIG. 11 is being oscillated for MR-TOF mass analysis. However, particle beam source 1108 can be used to fragment ions being oscillated in ELIT 610 for any type of mass analysis. Particle beam source 1108 can be, but is not limited to, a laser, a neutral atom beam source, or an electron beam source, and the beam of particles can be, but are not limited to, a beam of photons, beam of neutral atoms, or a beam of electrons, respectively.

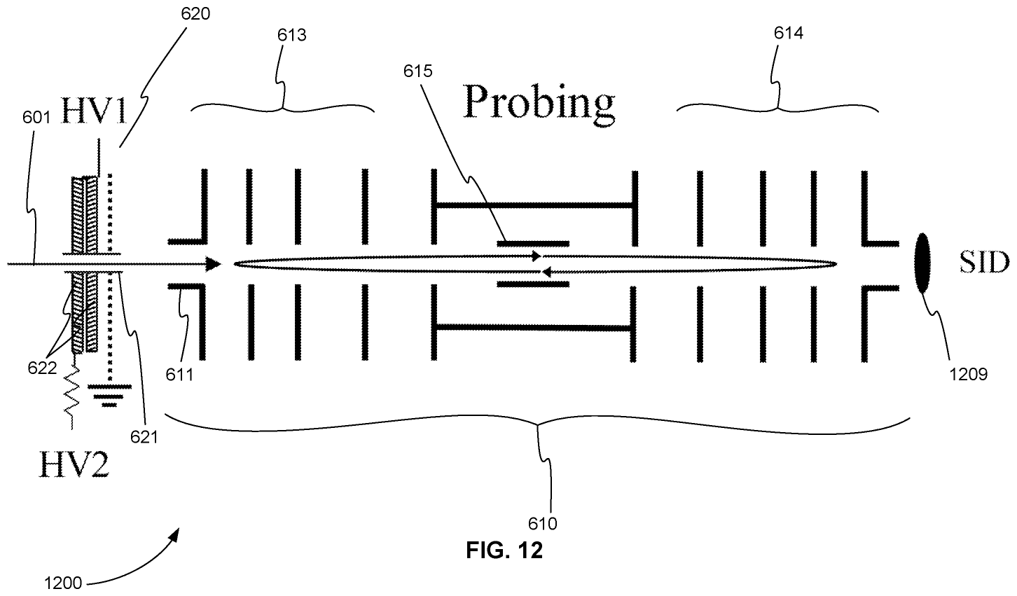

FIG. 12 is an exemplary side view 1200 of an ELIT and an MCP detector that includes coaxial rings of MCPs surrounding a hollow central cylindrical tube and that is positioned at the entrance port of the ELIT and shows how the ELIT performs surface induced dissociation (SID), in accordance with various embodiments. In FIG. 12, MCP detector 620 is again in front of ELIT 610. SID surface 1209 is further positioned on the side of ELIT 610 opposite MCP detector 620.

During SID, ELIT 610 transmits ions of an ion packet through the holes of second set of reflectron plates 614 to SID surface 1209 for fragmentation. ELIT 610 receives the fragmented ions through the holes of second set of reflectron plates 614 immediately after fragmentation. The oscillating ions shown in FIG. 12 are being oscillated for FT mass analysis. However, SID can be used in conjunction with any type of mass analysis.

FIGS. 9-12 show that using an MCP detector made up of coaxial rings of MCPs surrounding a hollow central cylindrical tube allows an ELIT to be used with additional mass spectrometry devices. In other words, the use of an MCP detector that does not obstruct the ion path to or from an ELIT allows the ELIT to be used with additional mass spectrometry devices.

U.S. Pat. No. 6,943,344 (hereinafter the “'344 Patent”) describes an exemplary MCP detector made up of a pin anode and coaxial rings of MCPs surrounding a hollow center tube. Ecelberger, S. A. et al. (2004), “Suitcase TOF: a man-portable time-of-flight mass spectrometer,” Johns Hopkins APL technical digest 25(1): 14-19 (hereinafter the “Ecelberger Paper”), describe using an MCP detector like the MCP detector of the '344 Patent to detect ions in a miniature TOF mass analyzer. According to the Ecelberger Paper, ions in the drift region of a miniature TOF mass analyzer can pass through the center tube of the MCP detector. These ions are then reflected by a single reflectron back to the drift region and detected by the coaxial rings of MCPs of the MCP detector.

Neither the '344 Patent nor the Ecelberger Paper suggests using an MCP detector with a hollow center to prevent the MCP detector from obstructing the ion path of a mass spectrometer. In fact, both the '344 Patent and the Ecelberger Paper explicitly apply their MCP detectors within a miniature TOF device that is a terminal device. As a result, the '344 Patent and the Ecelberger Paper do not contemplate transmitting ions back out through the miniature TOF device or deflecting ions from the ion path once the ions are transmitted from the miniature TOF device.

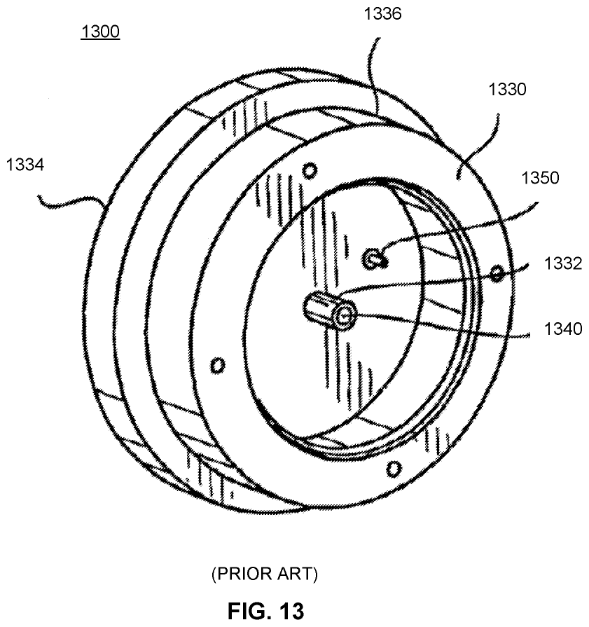

FIG. 13 is a perspective front view of the MCP detector assembly 1300 of U.S. Pat. No. 6,943,344. As described in the '344 Patent, detector assembly 1300 includes collection pin anode 1350 and cylindrical mount 1330 having a tube 1332. The tube 1332 extends from a center thereof and a shield 1334 encircles an outer surface 1336. The tube 1332 lies along a central axis 1340.

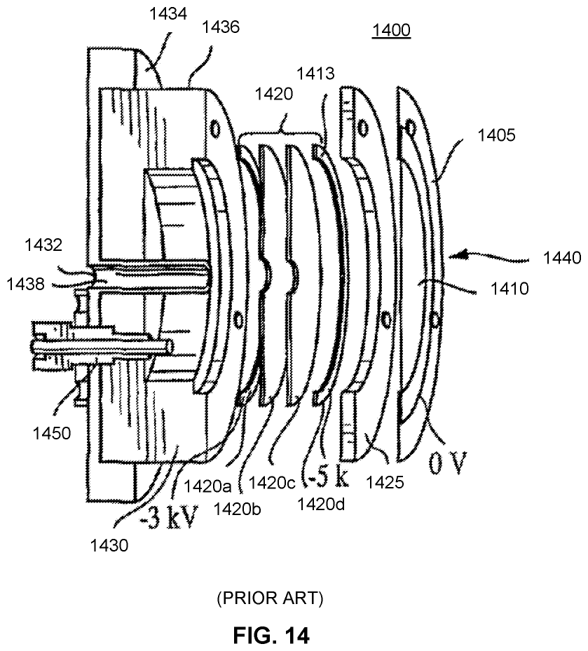

FIG. 14 is an expanded cutaway side view of the MCP detector assembly 1400 of U.S. Pat. No. 6,943,344. As described in the '344 Patent, the assembly 1400 includes a clamping ring 1405 having an entrance grid 1410 which is held at ground potential while a front surface 1413 of a center-hole micro-channel plate assembly 1420 is set to approximately −5 kV, post-accelerating ions to 5 keV. The plate assembly 1420 includes four components: a rear conducting ring 1420a, a rear channel plate 1420b, a front channel plate 1420c, and a front conducting ring 1420d. The conducting rings 1420a, 1420d behave as electrodes to apply voltage to the channel plates 1420b, 1420c as known in the art.

The clamping ring 1405 is bolted to an inner ring 1425. The inner ring 1425 is bolted to a cylindrical mount 1430 having a tube 1432 extending from a center thereof and a shield 1434 encircling an outer surface 1436. The shield 1434 is fabricated from any type of conducting material, such as aluminum, or stainless-steel foil. The rear conducting ring 1420a rests on a lip 1438 defined by the cylindrical mount 1430. The tube 1432 lies along a central axis 1440 of the detector assembly 1400. Using voltage divider resistors, the rear conducting ring 1420a is held at approximately −3 kV.

Since the collection pin anode 1450 is isolated from the detector assembly 1400, its potential isdefined by the oscilloscope's front-end amplifier (nominally ground).

In various embodiments, a ring MCP can be placed before and after an ELIT, allowing ions to be ejected and detected from either side. The ring MCP can be bidirectional, i.e. two of the structures pointed in opposite directions. Using this device, the transmission efficiency can be tested through the orifice (useful for tuning) by measuring the number of ions that hit one side of the detector. The opposing side of the detector can be used as described in the '344 Patent. If the tube is tilted (not perpendicular to the surface of the MCP), the assembly could be used to offset the ion beam and prevent gas carryover between differentially pumped regions of the mass spectrometer.

### System for Detecting Ions from an ELIT

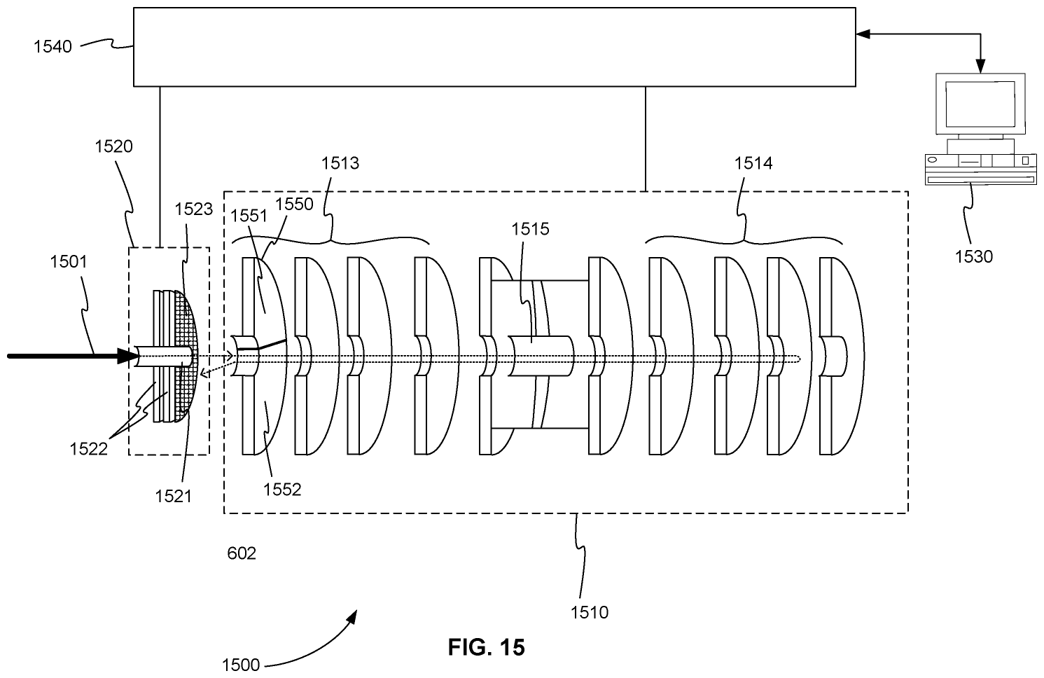

FIG. 15 is a schematic diagram 1500 of a system for detecting ions from an ELIT using an MCP detector that does not physically obstruct an ion path of a mass spectrometer, in accordance with various embodiments. The system of FIG. 15 includes ELIT 1510 and MCP detector 1520.

ELIT 1510 includes pickup electrode 1515, first set of reflectron plates 1513, and second set of reflectron plates 1514. Although the ELIT of FIG. 15 includes pickup electrode 1515, detection can also be performed using first set of reflectron plates 1513 and second set of reflectron plates 1514, using multiple electrodes (not shown), shaped electrodes (not shown), or any combination thereof.

Each plate of first set of reflectron plates 1513 includes a hole in the center and is aligned along ion path 1501 of a mass spectrometer. Each plate of second set of reflectron plates 1514 similarly includes a hole in the center and is aligned with first set of reflectron plates 1513 along ion path 1501.

MCP detector 1520 includes grid 1523 and coaxial rings of MCPs 1522 surrounding hollow central cylindrical tube 1521. MCP detector 1520 is aligned with first set of reflectron plates 1513 along ion path 1501. MCP detector 1520 is positioned on the side of first set of reflectron plates 1513 opposite second set of reflectron plates 1514.

MCP detector 1520 receives an ion packet along ion path 1501 through hollow central cylindrical tube 1521. MCP detector 1520 transmits the ion packet along ion path 1501 to the ELIT 1510 through the holes of first set of reflectron plates 1513 for at least one oscillation between first set of reflectron plates 1513 and second set of reflectron plates 1514.

ELIT 1510 transmits the oscillated ion packet back to MCP detector 1520 along ion path 1501 through the holes of first set of reflectron plates 1513. MCP detector 1520 detects ions of the oscillated ion packet that are radially deflected from ion path 1501 using rings of MCPs 1522.

In various embodiments, MCP detector 1520 applies a repulsive voltage to hollow central cylindrical tube 1521 to radially deflect ions of the oscillated packet from ion path 1501 and toward rings of MCPs 1522.

In various embodiments, the system of FIG. 15 further includes a radial deflector (not shown) positioned around hollow central cylindrical tube 1521 of MCP detector 1520 on a side facing first set of reflectron plates 1513. MCP detector 1520 applies a voltage to the radial deflector to radially deflect ions of the oscillated packet from ion path 1501 and toward rings of MCPs 1522. The radial deflector can be, but is not limited to, a conical electrode.

In various embodiments, a plate of first set of reflectron plates 1513 is used to radially deflect ions from ion path 1501. For example, first plate 1550 of first set of reflectron plates 1513 that is facing MCP detector 1520 is divided radially into two electrode sections 1551 and 1552. ELIT 1520 applies different voltages to the two electrode sections 1551 and 1552 to radially deflect ions of the oscillated packet from ion path 1501 and toward rings of MCPs 1522.

Note that in FIG. 15 first plate 1550 is divided into two electrode sections 1551 and 1552. In various embodiments, first plate 1550 can be divided into more than two electrode sections.

In various embodiments, in order to perform R-TOF mass analysis, ELIT 1510 oscillates the ion packet once to and from second set of reflectron plates 1514. This is shown in FIG. 6.

In various embodiments, in order to perform MR-TOF mass analysis, ELIT 1510 oscillates the ion packet more than once between first set of reflectron plates 1513 and second set of reflectron plates 1514. This is shown in FIG. 7.

In various embodiments, in order to perform FT mass analysis, MCP detector 1520 receives an ion packet along ion path 1501 through hollow central cylindrical tube 1521. MCP detector 1520 transmits the ion packet along ion path 1501 to ELIT 1510 through the holes of first set of reflectron plates 1513 for one or more oscillations between first set of reflectron plates 1513 and second set of reflectron plates 1514. This is shown in FIG. 8.

In various embodiments, in order to transmit ions along the ion path 1501 through ELIT 1510, MCP detector 1520 receives an ion packet along ion path 1501 through hollow central cylindrical tube 1522. MCP detector 1520 transmits the ion packet along ion path 1501 to ELIT 1510 through the holes of first set of reflectron plates 1513 for transmission of the ion packet from first set of reflectron plates 1513 to second set of reflectron plates 1514 and out of ELIT 1510 through the holes of second set of reflectron plates 1514 to another device (not shown) of the mass spectrometer. Ion transmission is shown in FIG. 9.

In various embodiments, the system of FIG. 15 further includes a laser (not shown) and a surface (not shown) for receiving a sample (not shown). The laser and the surface are positioned on the side of MCP detector 1520 opposite ELIT 1510. The laser ionizes a sample on the surface using matrix-assisted laser desorption/ionization (MALDI) to produce the ion packet. This is shown in FIG. 10. Ionization can also be performed by other means such as electrospray ionization.

In various embodiments, the system of FIG. 15 further includes a surface (not shown) positioned on the side of ELIT 1510 opposite MCP detector 1520 and positioned perpendicular to ion path 1501. To perform surface induced dissociation (SID) along ion path 1501, MCP detector 1520 receives an ion packet along ion path 1501 through hollow central cylindrical tube 1522, transmits the ion packet along ion path 1501 to ELIT 1510 through the holes of first set of reflectron plates 1513 for transmission of the ion packet from first set of reflectron plates 1513 to second set of reflectron plates 1514 and out of ELIT 1510 through the holes of second set of reflectron plates 1514 to the surface for SID. ELIT 1510 receives the fragmented ion packet from the surface through the holes of second set of reflectron plates 1514. This is shown in FIG. 12.

In various embodiments, the system of FIG. 15 further includes a particle beam source (not shown) positioned on a side of ELIT 1510 opposite MCP detector 1520 in order to direct a beam of particles along ion path 1501 and through the holes of second set of reflectron plates 1514 to in situ fragment the oscillated ion packet. This is shown in FIG. 11. In various embodiments, the particle beam source is a laser, a neutral atom beam source, or an electron beam source, and the beam of particles is a beam of photons, beam of neutral atoms, or a beam of electrons, respectively. As stated before, this particle beam source can be positioned radially and directed through the turning point of the reflectrons. Then, one could also include a SID apparatus, allowing for MCP detection, and two types of fragmentation, or MCP detection, one type of fragmentation, and additional mass spectrometry devices, such as a quadrupole.

In various embodiments, the system of FIG. 15 further includes one or more voltage sources 1540. The one or more voltage sources 1540 apply different voltages to one or more electrodes of ELIT 1510 and MCP detector 1520.

In various embodiments, processor 1530 is used to control or provide instructions to ELIT 1510 and MCP detector 1520 and to analyze data collected. Processor 1530 controls or provides instructions by, for example, controlling one or more voltage sources 1540. Processor 1530 can also control one or more current or pressure sources (not shown). Alternatively, processor 1530 can directly apply currents or voltages. Processor 1530 can be a separate device as shown in FIG. 15 or can be a processor or controller of one or more devices of a mass spectrometer (not shown). Processor 1530 can be, but is not limited to, a controller, a computer, a microprocessor, the computer system of FIG. 1, or any device capable of sending and receiving control signals and data.

### Method for Detecting Ions from and ELIT

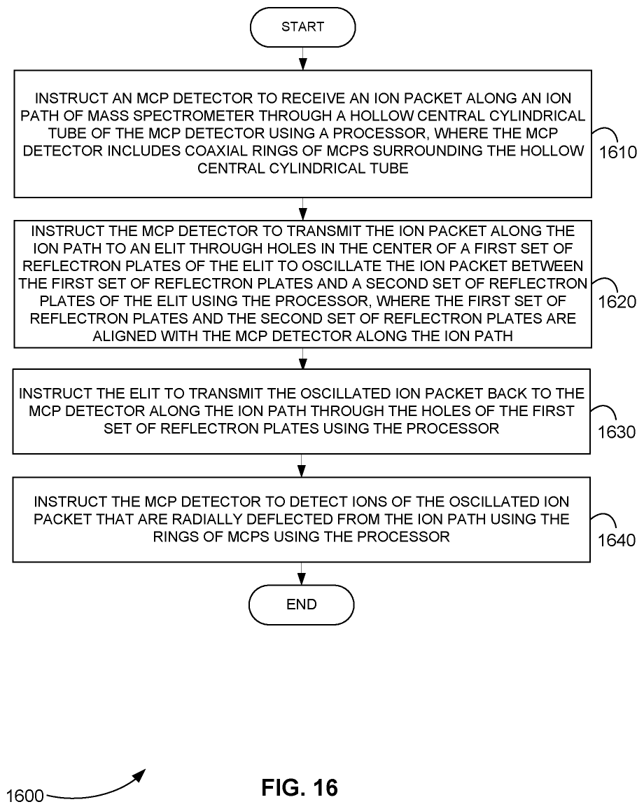

FIG. 16 is a flowchart showing a method 1600 for detecting ions from an ELIT using an MCP detector that does not physically obstruct an ion path of a mass spectrometer, in accordance with various embodiments.

In step 1610 of method 1600, an MCP detector is instructed to receive an ion packet along an ion path of mass spectrometer through a hollow central cylindrical tube of the MCP detector using a processor. The MCP detector includes coaxial rings of MCPs surrounding the hollow central cylindrical tube.

In step 1620, the MCP detector is instructed to transmit the ion packet along the ion path to an ELIT through holes in the center of a first set of reflectron plates of the ELIT to oscillate the ion packet between the first set of reflectron plates and a second set of reflectron plates of the ELIT using the processor. The first set of reflectron plates and the second set of reflectron plates are aligned with the MCP detector along the ion path.

In step 1630, the ELIT is instructed to transmit the oscillated ion packet back to the MCP detector along the ion path through the holes of the first set of reflectron plates using the processor.

In step 1640, the MCP detector is instructed to detect ions of the oscillated ion packet that are radially deflected from the ion path using the rings of MCPs using the processor.

### Computer Program Product for Detecting Ions from an ELIT

In various embodiments, computer program products include a tangible computer-readable storage medium whose contents include a program with instructions being executed on a processor so as to perform a method for detecting ions from an ELIT using an MCP detector that does not physically obstruct an ion path of a mass spectrometer. This method is performed by a system that includes one or more distinct software modules.

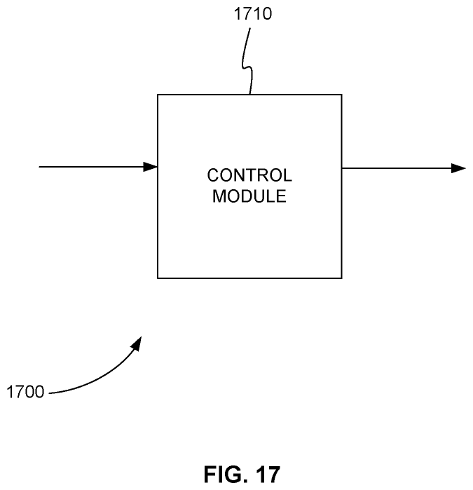

FIG. 17 is a schematic diagram of a system 1700 that includes one or more distinct software modules that perform a method for detecting ions from an ELIT using an MCP detector that does not physically obstruct an ion path of a mass spectrometer, in accordance with various embodiments. System 1700 includes a control module 1710.

Control module 1710 instructs an MCP detector to receive an ion packet along an ion path of mass spectrometer through a hollow central cylindrical tube of the MCP detector. The MCP detector includes coaxial rings of MCPs surrounding the hollow central cylindrical tube.

Control module 1710 instructs the MCP detector to transmit the ion packet along the ion path to an ELIT through holes in the center of a first set of reflectron plates of the ELIT to oscillate the ion packet between the first set of reflectron plates and a second set of reflectron plates of the ELIT. The first set of reflectron plates and the second set of reflectron plates are aligned with the MCP detector along the ion path.

Control module 1710 instructs the ELIT to transmit the oscillated ion packet back to the MCP detector along the ion path through the holes of the first set of reflectron plates. Finally, control module 1710 instructs the MCP detector to detect ions of the oscillated ion packet that are radially deflected from the ion path using the rings of MCPs.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for detecting ions from an electrostatic linear ion trap (ELIT) using a microchannel plate (MCP) detector that does not physically obstruct an ion path of a mass spectrometer, comprising:
an ELIT that includes
a first set of reflectron plates with holes in the center aligned along an ion path of a mass spectrometer, and
a second set of reflectron plates with holes in the center that is aligned with the first set along the ion path; and
an MCP detector that includes coaxial rings of MCPs surrounding a hollow central cylindrical tube, that is aligned with the first set of reflectron plates along the ion path, and that is positioned on a side of the first set opposite the second set, wherein the MCP detector receives an ion packet along the ion path through the hollow central cylindrical tube and transmits the ion packet along the ion path to the ELIT through the holes of the first set for at least one oscillation between the first set and the second set, wherein the ELIT transmits the oscillated ion packet back to the MCP detector along the ion path through the holes of the first set, and wherein the MCP detector detects ions of the oscillated ion packet that are radially deflected from the ion path using the rings of MCPs.

2. The system of claim 1, wherein the MCP detector applies a repulsive voltage to the tube to radially deflect ions of the oscillated packet from the ion path and toward the rings of MCPs.

3. The system of claim 1, further comprising a radial deflector positioned around the tube of the MCP detector on a side facing the first set, wherein the MCP detector applies a voltage to the radial deflector to radially deflect ions of the oscillated packet from the ion path and toward the rings of MCPs.

4. The system of claim 3, wherein the radial deflector comprises a conical electrode.

5. The system of claim 1, wherein a plate of the first set that is facing the MCP detector is divided radially into two or more electrode sections and wherein the ELIT applies different voltages to the two or more electrode sections to radially deflect ions of the oscillated packet from the ion path and toward the rings of MCPs.

6. The system of claim 1, wherein, to perform reflectron time-of-flight (R-TOF) mass analysis, the ELIT oscillates the ion packet once to and from the second set.

7. The system of claim 1, wherein, to perform multiple reflectron time-of-flight (MR-TOF) mass analysis, the ELIT oscillates the ion packet more than once between the first set and the second set.

8. The system of claim 1, wherein, to perform Fourier transform (FT) mass analysis, the MCP detector receives an ion packet along the ion path through the hollow central cylindrical tube and transmits the ion packet along the ion path to the ELIT through the holes of the first set for one or more oscillations between the first set and the second set.

9. The system of claim 1, wherein, to transmit ions along the ion path, the MCP detector receives an ion packet along the ion path through the hollow central cylindrical tube and transmits the ion packet along the ion path to the ELIT through the holes of the first set for transmission of the ion packet from the first set to the second set and out of the ELIT through the holes of the second set to another device of the mass spectrometer.

10. The system of claim 1, further including a laser and a surface for receiving a sample that are positioned on a side of the MCP detector opposite the ELIT, wherein the laser ionizes a sample on the surface using matrix-assisted laser desorption/ionization (MALDI) to produce the ion packet.

11. The system of claim 1, further including a surface positioned on a side of the ELIT opposite the MCP detector and positioned perpendicular to the ion path, wherein, to perform surface induced dissociation (SID) along the ion path, the MCP detector receives a ion packet along the ion path through the hollow central cylindrical tube, transmits the ion packet along the ion path to the ELIT through the holes of the first set for transmission of the ion packet from the first set to the second set and out of the ELIT through the holes of the second set to the surface for SID, and the ELIT recieves the fragmented ion packet from the surface through the holes of the second set.

12. The system of claim 1, further including a particle beam source positioned on a side of the ELIT opposite the MCP detector in order to direct a beam of particles along the ion path and through the holes of the second set to in situ fragment the oscillated ion packet.

13. The system of claim 1, wherein the particle beam source comprises a laser, a neutral atom beam source, or an electron beam source and the beam of particles comprises a beam of photons, beam of neutral atoms, or a beam of electrons, respectively.

14. A method for detecting ions from an electrostatic linear ion trap (ELIT) using a microchannel plate (MCP) detector that does not physically obstruct an ion path of a mass spectrometer, comprising:
instructing an MCP detector to receive an ion packet along an ion path of mass spectrometer through a hollow central cylindrical tube of the MCP detector using a processor, wherein the MCP detector includes coaxial rings of MCPs surrounding the hollow central cylindrical tube;
instructing the MCP detector to transmit the ion packet along the ion path to an ELIT through holes in the center of a first set of reflectron plates of the ELIT to oscillate the ion packet between the first set and a second set of reflectron plates of the ELIT using the processor, wherein the first set and the second set are aligned with the MCP detector along the ion path;
instructing the ELIT to transmit the oscillated ion packet back to the MCP detector along the ion path through the holes of the first set using the processor; and
instructing the MCP detector to detect ions of the oscillated ion packet that are radially deflected from the ion path using the rings of MCPs using the processor.

15. A computer program product, comprising a non-transitory and tangible computer-readable storage medium whose contents include a program with instructions being executed on a processor to perform a method for detecting ions from an electrostatic linear ion trap (ELIT) using a microchannel plate (MCP) detector that does not physically obstruct an ion path of a mass spectrometer, comprising:
providing a system, wherein the system comprises one or more distinct software modules, and wherein the distinct software modules comprise a control module;
instructing an MCP detector to receive an ion packet along an ion path of mass spectrometer through a hollow central cylindrical tube of the MCP detector using the control module, wherein the MCP detector includes coaxial rings of MCPs surrounding the hollow central cylindrical tube;
instructing the MCP detector to transmit the ion packet along the ion path to an ELIT through holes in the center of a first set of reflectron plates of the ELIT to oscillate the ion packet between the first set and a second set of reflectron plates of the ELIT using the control module, wherein the first set and the second set are aligned with the MCP detector along the ion path;
instructing the ELIT to transmit the oscillated ion packet back to the MCP detector along the ion path through the holes of the first set using the control module; and
instructing the MCP detector to detect ions of the oscillated ion packet that are radially deflected from the ion path using the rings of MCPs using the control module.
